(19) United States
(12) Patent Application Publication
(10) Pub. No.: US 2024/0193643 A1
(43) Pub. Date: Jun. 13, 2024

(54) Technologies for Collecting and Communicating Verified Reviews of Products

(71) Applicant: FETCH REWARDS, INC., Chicago, IL (US)

(72) Inventors: Peter Bond, Guilford, CT (US); Patrick Burke, Lake Forest, IL (US)

(21) Appl. No.: 18/080,553

(22) Filed: Dec. 13, 2022

(51) Int. Cl. G06Q 30/0282; G06Q 30/0217

(52) U.S. Cl. CPC G06Q 30/0282; G06Q 30/0217

(57) ABSTRACT

Systems and methods for managing digital rewards for users associated with completion of product reviews by the users. According to certain aspects, a server determines that a user purchased a given product, and offers a digital reward to the user for completing a review of the given product. An electronic device enables the user to complete the review and communicates the review to a digital repository that avails the review for use by a website. The server interfaces with the digital repository to determine that the user completed the digital review, and applies the digital reward to an account of the user.

### FIELD

The present disclosure is directed to technologies for offering digital rewards to users who purchase products. More particularly, the present disclosure is directed to platforms and techniques for enabling users to complete reviews of purchased products, determining whether the users actually complete the reviews of products, and automatically applying digital rewards to user accounts.

### BACKGROUND

Individuals commonly use the internet in an ecommerce capacity to purchase various goods, products, and/or services, or to research known or new products, such as in contemplation of purchasing the products. It is estimated that when a user is searching a given website for products offered by that website, about 35% of products added to a digital shopping cart are found via search queries, about 60% of products added to a digital shopping cart from search are from the first four positions in the search results, and about 95% of products added to a digital shopping cart from search originate from the first page of search results. Generally, two of the product content elements that are most highly correlated with search result placement (i.e., how high in the search results) are average rating (e.g., a star rating) and review count (i.e., a number of reviews). That is, a given product generally moves up in search result placement as the product ratings improve and/or as its review count increases; and vice-versa. Therefore, an entity associated with a given product is incentivized to improve product ratings and increase review count. Generally, product reviews consisting of ratings and/or descriptions are known as user-generated content (UGC).

Currently, entities employ various techniques to collect UGC. In particular, some online retailers and direct-to-consumer (DTC) brands leverage application notifications and other electronic communications to solicit feedback from individuals. Additionally, brands behind certain shelf-stable (i.e., non-perishable) products leverage online sampling communities that offer free product samples in exchange for reviews of the products. Further, some brands may “rent” existing reviews from certain UGC collection sites, while other non-DTC brands may organically collect UGC through forms on product display pages (PDPs; i.e., websites that describe but do not necessarily sell the products).

However, each of these existing channels to solicit and collect UGC is expensive for brands and other entities, and it is generally cumbersome and inconvenient for users to complete reviews. For example, online sampling communities require the manufacture and shipment of product samples. For further example, users are not incentivized to complete product reviews when solicited by retailers or other entities. Indeed, it is estimated that only 5%-10% of consumers actually complete product reviews.

Accordingly, there is an opportunity to leverage certain technologies that incentivize users to complete product reviews and automatically detect the completion of product reviews associated with verified purchases so that users are properly rewarded.

### SUMMARY

In an embodiment, a computer-implemented method of managing user-submitted reviews of products is provided. The method may include: receiving, by at least one processor, an identification of a product purchased by a user; transmitting, to an electronic device of the user, an offer to review the product, wherein the electronic device (i) receives, via a user interface, a review of the product, and (ii) transmits the review of the product to a digital repository that avails the review of the product via a website associated with the product; retrieving, by the at least one processor from the digital repository, a set of contact information associated with a set of users; determining, by the at least one processor, that contact information of the user is included in the set of contact information retrieved from the digital repository; and in response to determining that the contact information of the user is included in the set of contact information: applying, by the at least one processor, a digital reward to an account of the user, and transmitting, to the electronic device of the user, a notification of the digital reward.

In another embodiment, a system for managing user-submitted reviews of products is provided. The system may include a transceiver in communication with an electronic device of a user, a memory storing a set of computer-readable instructions, and at least one processor interfacing with the transceiver and the memory. The at least one processor may be configured to execute the set of computer-readable instructions to cause the at least one processor to: receive an identification of a product purchased by the user, transmit, to the electronic device via the transceiver, an offer to review the product, wherein the electronic device (i) receives, via a user interface, a review of the product, and (ii) transmits the review of the product to a digital repository that avails the review of the product via a website associated with the product, retrieve, from the digital repository, a set of contact information associated with a set of users, determine that contact information of the user is included in the set of contact information retrieved from the digital repository, and in response to determining that the contact information of the user is included in the set of contact information: apply a digital reward to an account of the user, and transmit, to the electronic device via the transceiver, a notification of the digital reward.

Further, in an embodiment, a system for managing digital rewards associated with product reviews is provided. The system may include a memory storing a set of computer-readable instructions, and at least one processor interfacing with the memory. The at least one processor may be configured to execute the set of computer-readable instructions to cause the at least one processor to: determine that a user purchased a product, wherein there is a digital reward associated with the user completing a review of the product, avail a notification of the digital reward to an account associated with the user, access the review of the product, the review of the product including contact information associated with a submission of the review of the product, wherein the review of the product is availed via a website associated with the product, determine that the contact information included in the review of the product matches stored contact information associated with the account associated with the user, and in response to determining that the contact information matches the stored contact information, apply the digital reward to the account of the user.

### BRIEF DESCRIPTION OF THE FIGURES

FIG. 1 depicts an overview of components and entities associated with the systems and methods, in accordance with some embodiments.

FIG. 2 depicts an example signal diagram associated with compiling and availing digital reviews of products, in accordance with some embodiments.

FIGS. 3A-3D are example interfaces depicting the offering, completing, and submitting of a digital review, in accordance with some embodiments.

FIG. 4 illustrates an example flow diagram of managing user-submitted reviews of products, in accordance with some embodiments.

FIG. 5 is an example hardware diagram of an electronic device and a server configured to perform various functionalities, in accordance with some embodiments.

### DETAILED DESCRIPTION

The present embodiments may relate to, inter alia, identifying products purchased by users and offering digital rewards to users for completing reviews of the products. According to certain aspects, systems and methods may determine that users have purchased products, automatically detect that the users complete reviews of the products, and apply appropriate digital rewards to accounts of the users for completing the product reviews, where the product reviews may be availed to appropriate websites or platforms.

In embodiments, the systems and methods may determine that a set of users has purchased a set of products, and determine digital rewards to offer the set of users for completing a set of product reviews for the set of products. The set of users may use electronic devices to complete and submit the set of product reviews, and the systems and methods may detect that a given product review has been completed by a given user. As a result, the systems and methods may apply a corresponding digital reward to an account of the given user.

Generally, a review of a product may consist of some combination of a rating (e.g., a star rating or some other numerical or quantitative rating) and a textual description of the product. Further, a digital reward may be in the form of digital points, digital tokens, and/or the like, that may be applied to and reflected in an account of a given user. Generally, digital rewards may be accumulated (e.g., a cumulative amount of points) and may be redeemed for various rewards, including discounts, physical products, services, real-world or virtual experiences, and/or other rewards.

The systems and methods therefore offer numerous benefits. In particular, the systems and methods employ various data collection and data analysis techniques to effectively determine digital reward eligibility and collect product reviews from electronic devices of users who are verified purchasers of the products. Further, the systems and methods employ multiple servers and platforms to effectively and accurately determine that a given user has completed a product review, which results in the systems and methods automatically applying a corresponding digital reward to an account of the user.

As a result of increased product reviews, a brand or other entity associated with a given product may experience better search result placement (i.e., increased search engine optimization (SEO)) in websites or other platforms that offer the products for sale or otherwise describe the products, which can result in increased sales and brand recognition, among other benefits. The systems and methods further enable the generation and collection of UGC for more challenging categories like alcohol and perishables where, for example, sampling is not an option. Indeed, the systems and methods eliminate the need for certain brands or other entities to conduct sampling campaigns altogether. Additionally, a brand or other entity may own the UGC for various marketing efforts or other purposes, and may avoid review recency issues by virtue of a regular flow of new UGC. It should be appreciated that additional benefits are envisioned.

The systems and methods represent an improvement to an existing technology(ies), namely technologies for compiling and verifying of product reviews, and/or technologies for availing product reviews on websites and other platforms. Existing solutions for collecting reviews involve brands physically shipping products to users, where the users complete and submit reviews for the products. Other existing solutions involve brands paying to “rent” existing reviews and avail the existing reviews on websites. Additional existing solutions involve brands soliciting reviews from users which the brands then use on websites. These solutions, however, suffer from multiple drawbacks.

In particular, brands, merchants, and other entities cannot readily verify that a given product review was associated with an actual purchase of the product. Additionally, even if a product has been purchased and a review of the product has been completed, the brands, merchants, and other entities also cannot verify that the product review was completed by a user who actually purchased (and is presumably using and/or consuming) the product. These drawbacks impact the quality and credibility of the reviews, which can ultimately lead to distrust of a given retailer, fewer product sales, and other issues.

The systems and methods improve on these existing solutions in multiple ways. In particular, by interfacing with a purchase history of a given user or analyzing a receipt uploaded by the given user, the systems and methods accurately and effectively verify that the given user has actually purchased a given product. Additionally, by seamlessly matching contact information of a given user submitted in association with a digital review of a given product with contact information of the given user that is associated with a purchase of the given product, the systems and methods accurately and effectively verify that the digital review was completed and submitted by the given user who actually purchased (and is presumably using and/or consuming) the given product.

These improvements lead to increased quality and credibility of the reviews, as well as of the brands, merchants, retailers, and the like. Additionally, these improvements prevent situations in which “review farms”, bots, autonomous programs, and/or the like submit product reviews (i.e., spam reviews) that are neither associated with an actual purchase nor accurately reflect a real-world usage and/or consumption of the products. This, in turn, results in decreased amounts of spam reviews, which decreases a volume of network traffic, increases bandwidth availability, and improves website load times and website navigation, among other performance improvements.

Additionally, the systems and methods include more than mere instructions performed on a generic component or machinery. In particular, the systems and methods incorporate multiple electronic devices and/or servers via which electronic messages are communicated, queried, and retrieved. Additionally, the multiple electronic devices exchange reviews of products that are availed via websites or other platforms for access and review by additional electronic devices. The systems and methods further employ data matching determinations to verify that products have actually been purchased and that digital reviews of products are completed and submitted by users who actually purchased the products.

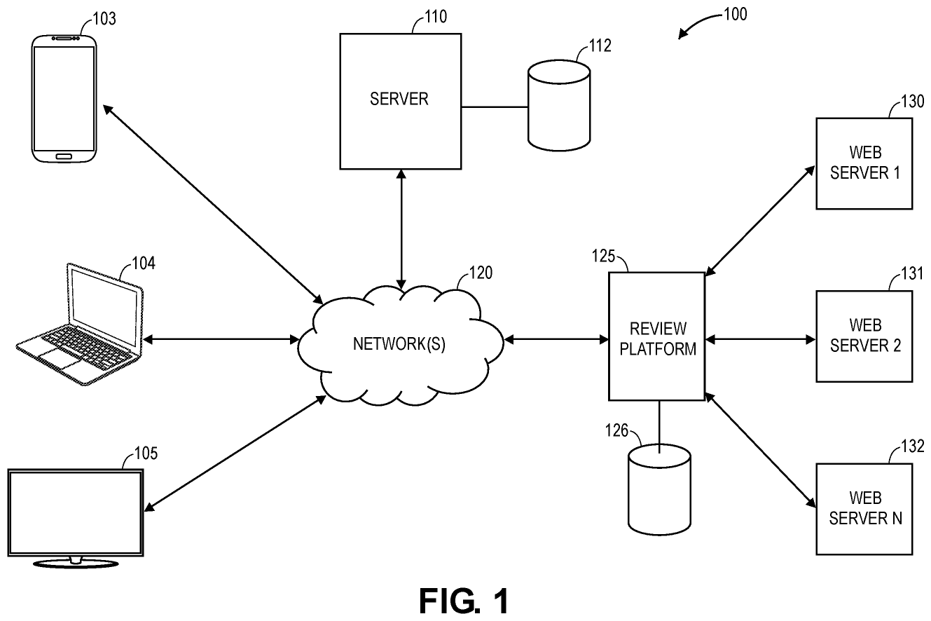

FIG. 1 illustrates an overview of a system 100 of components configured to facilitate the systems and methods. It should be appreciated that the system 100 is merely an example and that alternative or additional components are envisioned.

As illustrated in FIG. 1, the system 100 may include a set of electronic devices 103, 104, 105 which may be used or operated by a set of users, such as any individual or person who may be interested in purchasing items, products, and/or services (generally, as used herein, “products”) that may be offered for sale by an entity. In an embodiment, the entity may be a corporation, company, partnership, retailer, wholesaler operating on behalf of another entity (e.g., a white label wholesaler), or the like, where the entity may offer an ecommerce platform (e.g., a website accessible by or an application executable by the electronic devices 103, 104, 105) and optionally a set of brick-and-mortal retail stores. Each of the electronic devices 103, 104, 105 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like.

The electronic devices 103, 104, 105 may communicate with a server 110 via one or more networks 120. The server 110 may be associated with an entity (e.g., a corporation, company, partnership, or the like) that may manage and facilitate digital rewards for users, such as the set of users associated with the electronic devices 103, 104, 105. In particular, the server 110 may include or support a web server configured to host a website which with the electronic devices 103, 104, 105 may interface, such as to communicate indications of the purchase of any products, goods, and/or services, and/or to receive reviews for the products, goods, and/or services.

Further, the server 110 may support a software application executable by the set of electronic devices 103, 104, 105 (i.e., the set of electronic devices 103, 104, 105 may interface with the server 110 in executing the software application), where the user may use the software application to complete and submit product reviews. Additionally, the users of the electronic devices 103, 104, 105 may have an account with a service or application offered by the server 110. In embodiments, the network(s) 120 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

The server 110 may be configured to interface with or support a memory or storage 112 capable of storing various data, such as in one or more databases or other forms of storage. According to embodiments, the storage 112 may store data or information associated with any products or services that are offered for sale by an entity, including any purchase history(ies) of a set of users, any reviews of products/services provided by users, and/or other data.

The server 110 and the electronic devices 103, 104, 105 may communicate with a review platform 125 via the network(s) 120. According to embodiments, the review platform 125 may be operated by or associated with an entity such as a corporation, company, partnership, or the like, and may collect reviews for products or services as prepared or input by users, such as the users of the electronic devices 103, 104, 105. The review platform 125 may interface with a memory or storage 126 capable of storing various data, such as in one or more databases or other forms of storage. According to embodiments, the storage 126 may store data or information associated with any products or services that are offered for sale by an entity, including any websites or retailers that sell products and/or services, any reviews of products/services provided by users, and/or other data.

The review platform 125 may communicate with a set of web servers 130, 131, 132, such as via the network(s) 120, and/or additional electronic devices. According to embodiments, the set of web servers 130, 131, 132 may respectively host websites that offer products or services for sale (i.e., in an ecommerce capacity), or that provide information about products or services (e.g., as a product display page (PDP)) that may be for sale elsewhere (e.g., in a brick and mortar store or via another website). For example, the web server 130 may host an ecommerce platform that offers various electronics for sale, and the web server 131 may host a website with information about various consumables (e.g., drinks, foods, etc.) for a brand that are offered for sale at various grocery stores.

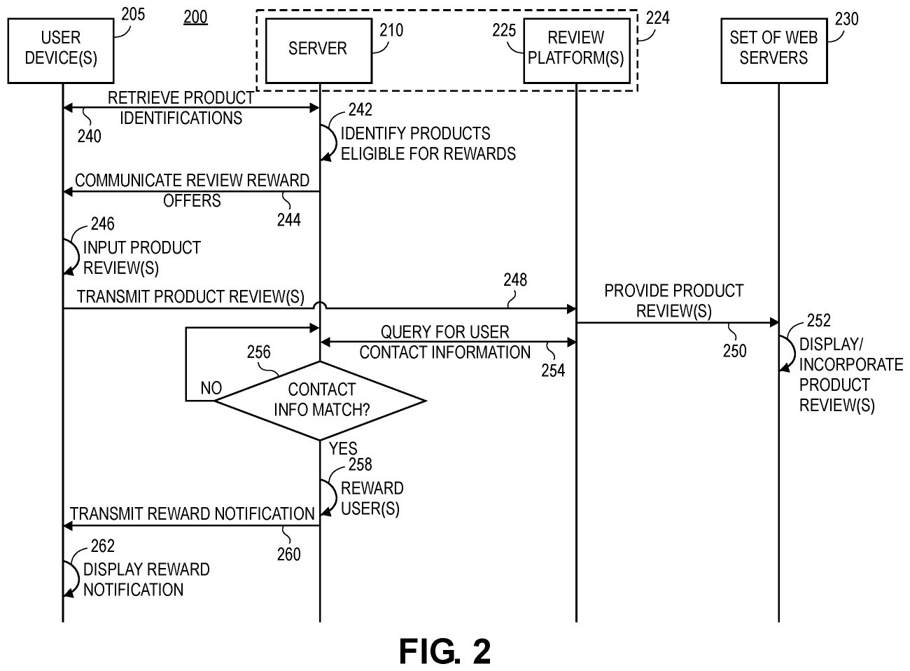

According to embodiments, the server 110 may communicate with the set of web servers 120, 131, 132, such as to retrieve product purchase histories of users. Further, the server 110 may determine, by examining various data, which users have purchased which products, and may communicate, to the electronic devices 103, 104, 105, offers of digital rewards for the users to complete and submit reviews for the products. The users may use the electronic devices 103, 104, 105 to input or compose reviews of purchased products, where the electronic devices 103, 104, 105 may transmit the reviews to the review platform 125 via the network(s) 120. In turn, the review platform 125 may determine how to distribute or avail the reviews to the appropriate web server(s) 130, 131, 132. The server 110 may communicate with the review platform 125 to determine which user(s) submitted a review(s), and accordingly apply a digital reward(s) to an account(s) of that users(s). FIG. 2 and the corresponding description provides additional details regarding these functionalities.

Although depicted as a single server 110 in FIG. 1, it should be appreciated that the server 110 may be in the form of a distributed cluster of computers, servers, machines, or the like. In this implementation, the entity may utilize the distributed server(s) 110 as part of an on-demand cloud computing platform. Accordingly, when the electronic devices 103, 104, 105 interface with the server 110, the electronic devices 103, 104, 105 may actually interface with one or more of a number of distributed computers, servers, machines, or the like, to facilitate the described functionalities. Additionally, although depicted and described as separate components, in some embodiments the server 110 and the review platform 125 may be combined into a single component.

Further, although three (3) electronic devices 103, 104, 105, one (1) server 110, one (1) review platform 125, and three (3) web servers 130, 131, 132 are depicted in FIG. 1, it should be appreciated that greater or fewer amounts are envisioned. For example, there may be multiple servers and/or review platforms, each one associated with a different entity. Additionally, the electronic devices 103, 104, 105 and the server 110 may interface with one or more separate, third-party servers (not depicted in FIG. 1) to retrieve relevant data and information.

FIG. 2 is a signal diagram 200 depicting various functionalities associated with the systems and methods. The signal diagram 200 includes a set of user devices 205 (such as one or more of the electronic devices 103, 104, 105 as discussed with respect to FIG. 1), a server 210 (such as the server 110 as discussed with respect to FIG. 1), a review platform 225 (such as the review platform 225 as discussed with respect to FIG. 1), and a set of web servers 230 (such as one or more of the web servers 130, 131, 132 as discussed with respect to FIG. 1). In an implementation, the server 210 and the review platform 225 may be combined into a single device 224, or otherwise associated with the same entity. In embodiments, each of a set of users associated with the user device(s) 205 may have an account with the server 210, where the account may reflect an amount of digital rewards (e.g., an amount of points) for the respective user.

The signal diagram 200 may begin when the server 210 retrieves (240), from the user device(s) 205, a set of product identifications. In an embodiment, a user of the user device(s) 205 may capture a digital image (e.g., using an image sensor of the user device(s) 205) of a receipt indicating a set of products that were purchased by the user, either within a brick and mortar store or via an ecommerce platform, where the user device(s) 205 may transmit or communicate the digital image to the server 210 via a network connection. In another embodiment, the server 210 may interface with another device, such as a third party server, that stores data identifying a purchase history of a user(s) associated with the user device(s) 205. For example, the third party server may be associated with an ecommerce platform or site that offers various products for purchase. For further example, the third party server may be an e-mail provider that receives and stores (e.g., in a user inbox) order confirmations indicating a purchase(s) made by a user(s) of the e-mail provider. In embodiments, the server 210 may identify a set of products that were purchased from one or more identifiers, such as a barcode, UPC, ISBN, GTIN, EAN, or other identification, where the identifier(s) may be included on a receipt or confirmation of a purchase of a product(s).

In this regard, the server 210 may retrieve the purchase history, analyze the purchase history, and identify any product(s) included in the purchase history and therefore purchased by the user. It should be appreciated that one or more of the products that may be identified from a given user's purchase history, e-mail, digital image, or the like may not have been physically or actually purchased by the given user, however by virtue of the one or more products being associated with the given user's purchase, history, e-mail, digital image, or the like, the server 210 may deem that the one or more products was purchased by the given user.

The server 210 may identify (242), from the set of product identifications retrieved in (240), a set of products that may be eligible for a digital reward. According to embodiments, a digital reward, as used herein, may be in the form of points, credits, tokens, real world currencies or cryptocurrencies, certificates, or the like that may be applied to and accumulated in an account for a given user that is maintained by the server 210. A user may redeem a digital reward(s) for various virtual or real-world products, services, experiences, discounts, and/or the like. For example, a certain amount of points may be redeemable for 10% off a subsequent purchase on a given website. For further example, a certain amount of crytocurrency tokens may be redeemed for a virtual clothing items for a digital avatar.

Generally, an entity (e.g., an entity(ies) associated with products offered for sale by the web server(s) 230) may want to offer a digital reward(s) for one or more products manufactured, distributed, or sold by the entity, where the server 210 may maintain a list of products that may be eligible for a digital reward. In embodiments, the review platform 225 or another source (e.g., the web server(s) 230) may send, to the server 210, a listing of products that are eligible for digital rewards. The listing may identify an amount for a digital reward for a given product, or the server 210 may determine or calculate a digital reward for a given product. According to embodiments, the digital reward for a given product may be tied to a user(s) of the user device(s) 205 composing and submitting a review of the given product.

The server 210 may communicate (244) a set of review reward offers to the user device(s) 205. In particular, the server 210 may communicate with the user device(s) 205 associated with a purchase for a given product included in the set of products eligible for a digital reward, where the server 210 may have previously determined that a user of the user device(s) 205 purchased the given product. It should be appreciated that a given reward offer for a given product may be for varying amount of points, tokens, credits, and/or the like. Further, in some situations, the user may have purchased multiple items from the same entity (e.g., multiple items from the same store), where there may be a reward offer available for each of these multiple items. In this situation, the offer may indicate a reward offer for each review that the user completes and submits. For example, if a given user purchases a bar of chocolate, a yogurt, and a juice drink from the same store, there may be a reward offer of 1,000 points for reviewing the bar of chocolate, 2,000 points for reviewing the yogurt, and 500 points for reviewing the juice drink.

According to embodiments, the server 210 may communicate the set of review reward offers in various manners. In one implementation in which the user device(s) 205 executes an application supported by the server 210, the server 210 may push or otherwise communicate a notification or message accessible by the application, where the notification or message indicates the review reward offer. In another implementation, the server 210 may cause an e-mail, SMS, or other type of electronic communication to be sent to an e-mail address, phone number, or other communication channel associated with the user(s) of the user device(s) 205. Generally, the server 210 may store information identifying which products are purchased by which users, contact information of the users, which users have been offered digital rewards to complete reviews, and/or related information.

The user device(s) 205 may receive (246) an input of a product review(s). In particular, a user(s) may use the user device(s) to compose a review for a given product, where the review may include a combination of a numerical or quantitative rating (e.g., a star rating between one (1) and five (5) stars) and/or a textual or qualitative description for the product. It should be appreciated that different types of formats for reviews, with different components thereof (e.g., numerical rating, description, etc.), are envisioned. In some embodiments, the user(s) may compose or enter the review using another electronic device, and the user device(s) 205 may access the review from that electronic device. Further, the user(s) may use the user device(s) 205 to input multiple product reviews for which digital rewards may be available.

The user device(s) 205 may transmit (248) the product review(s) to the review platform(s) 225 via a network connection(s). In embodiments, the product review(s) may be embodied as an electronic message, e-mail, or other type of electronic communication. Further, in embodiments, the review platform(s) 225 may receive the product review(s) from an electronic device other than the user device(s) 205. It should be appreciated that the review platform 225 may examine or analyze the product review(s) to identify or extract relevant or needed information, and/or reformat the information to align with any requirements of the web server(s) 230. For example, the review platform 225 may scrub certain identifying data such as an email address of the submitting user, and leave only a first name of the submitting user and the content of the product review.

The review platform(s) 225 may determine which web server(s) 230 to which to distribute the product review(s). In particular, the review platform(s) 225 may identify which web server(s) 230 has a website that offers a given product for sale, or otherwise promotes/describes that given product. In some embodiments, the review platform(s) 225 may have an arrangement or agreement with one or more of the web server(s) to provide product reviews. After the review platform(s) 225 determines how to distribute the product review(s), the review platform(s) 225 may provide (250) the product review(s) to the appropriate web server(s) 230.

The web server(s) 230 may display (252) or otherwise incorporate the product review(s) within or into the website(s). In particular, a product page selling or describing a specific product may incorporate or display any of the product review(s) associated with that specific product. In this regard, a user may access a website to review information and details regarding a specific product, including any product review(s) for that specific product, such as in contemplation of placing an order for the product or learning more about the product.

The server 210 may interface with the review platform 225 and query (254) the review platform 225 for user contact information, such as via an application programming interface (API), for example. In particular, the review platform 225 may store contact information (e.g., email addresses, phone numbers, addresses, names, etc.) associated with users of the user device(s) 205 who submit a product review(s), and the review platform 225 may provide various portions or all of this contact information to the server 210. Generally, upon receiving a product review from the user device(s) 205 in (248), the review platform 225 may store any user contact information included in the product review.

It should be appreciated that the server 210 may query for contact information received in association with a specific set of products, over a specific time period(s), within a certain geographic region(s), and/or other parameters. Further, it should be appreciated that the server 210 may query the review platform 225 for information continuously (e.g., via an API) or at periodic intervals (e.g., once per minute, etc.). In an implementation, the review platform 225 may automatically provide the information to the server 210 in response to receiving a review from the user device(s) 205. In embodiments, the server 210 may additionally retrieve a set of identifications of a set of products for which a user(s) submitted a product review(s). Accordingly, the server 210 may retrieve information indicating the products for which reviews have been completed as well as contact information for the users who submitted the product reviews.

According to embodiments, as explained herein, the server 210 may store contact information of users, such as in association with retrieving the product identifications in (240) and communicating the review reward offers in (244). The server 210 may determine (256) whether any of the contact information retrieved in (254) matches any of its stored contact information. For example, the server 210 may determine that an email address or phone number retrieved in (254) matches a stored email address or phone number for a user. If the server 210 does not determine or identify any matches in contact information (“NO”), processing may return to 254, end, or proceed to another functionality.

Generally, if the server 210 determines that there is at least one match in contact information (“YES”) associated with a given review for a given product, the server 210 may deem that a user who was initially offered a digital reward for reviewing the given product in (244) did, in fact, complete and submit a product review for that given product in (248). In this situation, the user is eligible for the reward that was offered in (244).

Accordingly, the server 210 may reward (258) the user(s) who submitted product reviews (i.e., the user(s) with matching contact information as determined in (256)). In particular, the server 210 may apply an amount of points, credits, or the like to an account(s) of a user(s) who completed and submitted a product review, where the amount of points, credits, or the like may align with an amount originally offered in the review reward offer. For example, if the server 210 offers a user 500 points to complete a review for a smart speaker and the user completes this product review, the server 210 may apply 500 points to an account of that user.

The server 210 may generate a notification for the reward and transmit (260) a notification of the reward to the user device(s) 205. It should be appreciated that the server 210 may communicate the notification to the user device(s) 205 using various channels, including a push notification, a text message, an email, and/or another electronic communication. The user device(s) 205 may display (262) the reward notification, such as via a user interface of the user device(s) 205. According to embodiments, a user may access or review the reward notification in another manner, such as by accessing a text messaging or email application, or via another manner. Continuing with the above example, the server 210 may communicate a notification to the user device 205 indicating that 500 points have been applied to the account of the user in association with the user completing the review for the smart speaker, and the user may access the user device 205 to review the notification as well as any information associated with the account, including a points balance, reward redemption options, and/or other information.

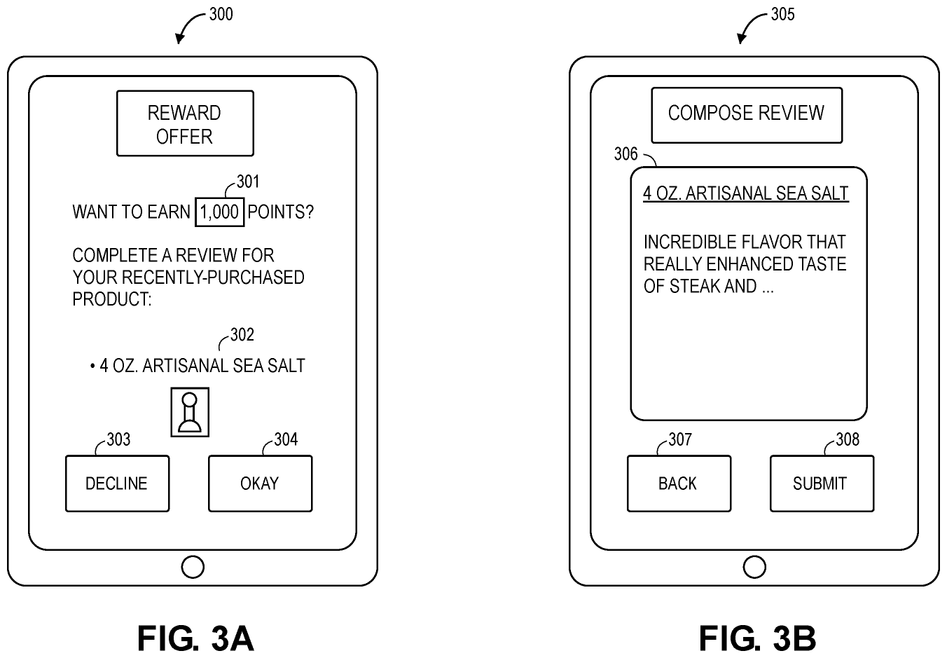

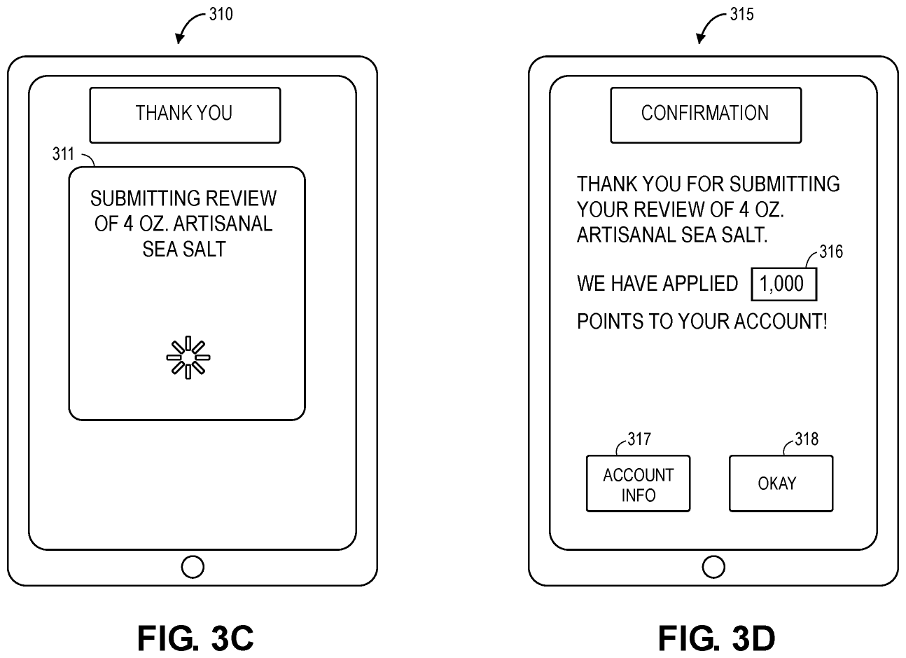

FIGS. 3A-3D depict example interfaces associated with the present embodiments. An electronic device (such as one of the electronic devices 103, 104, 105 as described with respect to FIG. 1 or the user device(s) 205 as described with respect to FIG. 2) may display the interfaces via a user interface, for review by and interaction with a user of the electronic device. It should be appreciated that the content and features of the interfaces is merely exemplary and that alternative or additional content and features are envisioned. Additionally, it should be appreciated that the content and features of the interfaces may be communicated in different ways or according to different techniques. For example, an offer for a digital reward may be communicated through e-mail, where the user may use e-mail or a website to complete and submit a product review. As another example, a user may be notified of an offer for a digital reward through a push or other type of notification, and the user may use a mobile application to complete and submit a product review.

FIG. 3A depicts an interface 300 that displays an offer for a digital reward. In particular, the interface 300 indicates an offer 301 for 1,000 points if the user completes a review for a recently-purchased item (as shown: 4 oz. artisanal sea salt (302)). The user may select to decline the offer via a decline selection 303 or select to complete the offer via an okay selection 304.

FIG. 3B depicts an interface 305 that enables the user to complete the review. In particular, the interface 305 may include a section 306 into which the user may input the review, such as via a digital keyboard or speech-to-text, for example. The user may select to navigate back to a previous interface via a back selection 307 or submit the review via a submit selection 308.

FIG. 3C depicts an interface 310 that indicates a submission of the digital review. The electronic device may display the interface 310 after the user selects the submit selection 308 of FIG. 3B, for example. The interface 310 may indicate in a section 311 that the digital review of the artisanal sea salt is being submitted.

FIG. 3D depicts an interface 315 that indicates a confirmation of the submission of the digital review. The interface 315 indicates, as referenced by 316, that 1,000 points have been applied to an account of the user. Additionally, the interface 315 may enable the user to review account information via an account info selection 317, or may enable to close the confirmation via an okay selection 318.

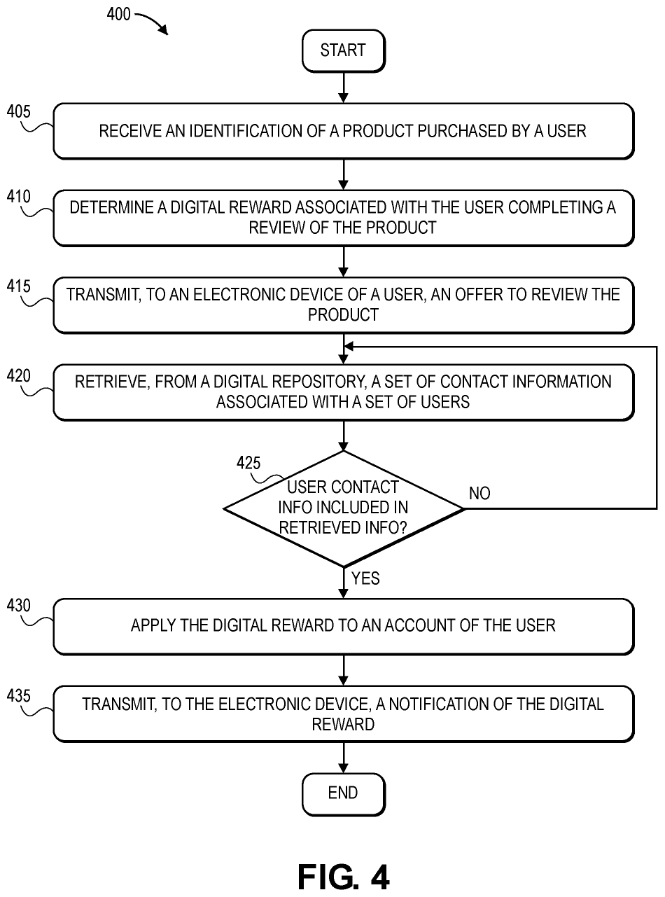

FIG. 4 depicts is a block diagram of an example method 400 of managing user-submitted reviews of products. The method 400 may be facilitated by a server (such as the server 210 as depicted in FIG. 2).

The method 400 may begin at block 405 in which the server receives an identification of a product purchased by a user. In embodiments, the server may receive, from an electronic device of the user, a digital image depicting a receipt indicating that the product was purchased, where the server may perform an image analysis on the digital image to determine that the product is included on the receipt. Further, in embodiments, the server may retrieve, from a digital repository associated with the user (e.g., an ecommerce platform), a digital record indicating that the product was purchased.

The server may determine (block 410) a digital reward associated with the user completing a review of the product. Further, the server may transmit (block 415), to the electronic device of the user, an offer to review the product, where the offer may indicate the digital reward. In embodiments, the electronic device may receive, via a user interface, a review of the product, and transmit the review of the product to a digital repository that avails the review of the product via a website associated with the product. Further, in embodiments, the website may offer the product for sale and the digital repository may send the review of the product to the website for incorporation by the website.

The server may retrieve (block 420), from the digital repository, a set of contact information associated with a set of users. In embodiments, the server may retrieve, from the digital repository, (i) the set of contact information associated with the set of users, and (ii) a set of products for which the set of users have completed a set of reviews. In embodiments, the digital repository may automatically send the set of contact information to the server, such as via an API. Further, the server may determine (block 425) whether contact information of the user is included in the set of contact information retrieved from the digital repository. If the contact information of the user is not included in the set of contract information (“NO”), processing may return to block 420, end, or proceed to other functionality. In contrast, if the contact information of the user is included in the set of contact information (“YES”), processing may proceed to block 430.

At block 430, the server may apply the digital reward to an account of the user. In embodiments, the account of the user may identify the contact information of the user (i.e., the contact information of the user may be associated with the account of the user). Further, at block 435, the server may transmit, to the electronic device, a notification of the digital reward. In this regard, the user may access the electronic device to ascertain a digital reward balance, redeem a digital reward, and/or facilitate other functionalities.

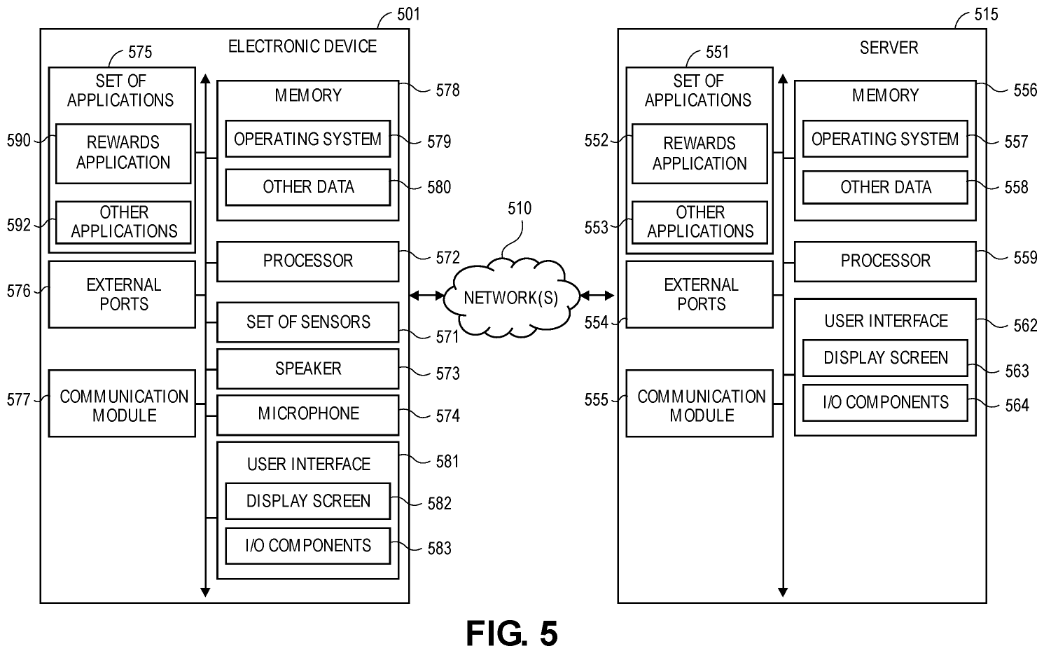

FIG. 5 illustrates a hardware diagram of an example electronic device 501 (e.g., one of the electronic devices 103, 104, 105, 205 as described with respect to FIGS. 1 and 2) and an example server 515 (e.g., one of the servers 110, 210 as described with respect to FIGS. 1 and 2), in which the functionalities as discussed herein may be implemented. It should be appreciated that the components of the electronic device 501 and the server 515 are merely exemplary, and that additional or alternative components and arrangements thereof are envisioned.

The electronic device 501 may include a processor 572 as well as a memory 578. The memory 578 may store an operating system 579 capable of facilitating the functionalities as discussed herein as well as a set of applications 575 (i.e., machine readable instructions). For example, one of the set of applications 575 may be a rewards application 590, such as to enable users to complete and submit product reviews, as well as interact with an account having associated digital rewards. It should be appreciated that one or more other applications 592 are envisioned.

The processor 572 may interface with the memory 578 to execute the operating system 579 and the set of applications 575. According to some embodiments, the memory 578 may also store other data 580 that may include data associated with the purchase of products, for example digital images depicting receipts associated with product purchases, contact information of users, and/or other data. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 501 may further include a communication module 577 configured to communicate data via one or more networks 510. According to some embodiments, the communication module 577 may include one or more transceivers (e.g., WAN, WWAN, WLAN, and/or WPAN transceivers) functioning in accordance with IEEE standards, 3GPP standards, or other standards, and configured to receive and transmit data via one or more external ports 576.

The electronic device 501 may include a set of sensors 571 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 501 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, and/or built in or external keyboard). In embodiments, a user of the electronic device 501 may be notified of an offer for a digital reward and input a product review via the user interface 581. Additionally, the electronic device 501 may include a speaker 573 configured to output audio data and a microphone 574 configured to detect audio.

In some embodiments, the electronic device 501 may perform the functionalities as discussed herein as part of a “cloud” network or may otherwise communicate with other hardware or software components within the cloud to send, retrieve, or otherwise analyze data.

As illustrated in FIG. 5, the electronic device 501 may communicate and interface with the server 515 via the network(s) 510. The server 515 may include a processor 559 as well as a memory 556. The memory 556 may store an operating system 557 capable of facilitating the functionalities as discussed herein as well as a set of applications 551 (i.e., machine readable instructions). For example, one of the set of applications 551 may be a rewards application 552. In embodiments, the rewards application 552 may be configured to determine digital reward eligibility, communicate offers for digital rewards, determine whether product reviews have been completed, and manage accounts associated with digital rewards. It should be appreciated that one or more other applications 553 are envisioned.

The processor 559 may interface with the memory 556 to execute the operating system 557 and the set of applications 551. According to some embodiments, the memory 556 may also store other data 558 such as product information, product reviews, and digital reward data. The memory 556 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 515 may further include a communication module 555 configured to communicate data via the one or more networks 510. According to some embodiments, the communication module 555 may include one or more transceivers (e.g., WAN, WWAN, WLAN, and/or WPAN transceivers) functioning in accordance with IEEE standards, 3GPP standards, or other standards, and configured to receive and transmit data via one or more external ports 554.

The server 515 may further include a user interface 562 configured to present information to a user and/or receive inputs from the user. As shown in FIG. 5, the user interface 562 may include a display screen 563 and I/O components 564 (e.g., ports, capacitive or resistive touch sensitive input panels, keys, buttons, lights, LEDs, external or built in keyboard). According to some embodiments, the user may access the server 515 via the user interface 562 to review information, make selections, and/or perform other functions.

In some embodiments, the server 515 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 572, 559 (e.g., working in connection with the respective operating systems 579, 557) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of managing user-submitted reviews of products, the method comprising:
receiving, by at least one processor, an identification of a product purchased by a user;
transmitting, to an electronic device of the user, an offer to review the product, wherein the electronic device (i) receives, via a user interface, a review of the product, and (ii) transmits the review of the product to a digital repository that avails the review of the product via a website associated with the product;
retrieving, by the at least one processor from the digital repository, a set of contact information associated with a set of users;
determining, by the at least one processor, that contact information of the user is included in the set of contact information retrieved from the digital repository; and
in response to determining that the contact information of the user is included in the set of contact information:
applying, by the at least one processor, a digital reward to an account of the user, and
transmitting, to the electronic device of the user, a notification of the digital reward.

2. The computer-implemented method of claim 1, wherein receiving the identification of the product purchased by the user comprises:
receiving, by the at least one processor from the electronic device, a digital image depicting a receipt indicating that the product was purchased.

3. The computer-implemented method of claim 2, further comprising:
performing, by the at least one processor, an image analysis on the digital image to determine that the product is included on the receipt.

4. The computer-implemented method of claim 1, wherein receiving the identification of the product purchased by the user comprises:
retrieving, by the at least one processor from an additional digital repository associated with the user, a digital record indicating that the product was purchased.

5. The computer-implemented method of claim 1, wherein the website offers the product for sale, and wherein the digital repository sends the review of the product to the website.

6. The computer-implemented method of claim 1, further comprising:
after receiving the identification of the product, determining, by the at least one processor, the digital reward associated with the user completing the review of the product.

7. The computer-implemented method of claim 1, wherein the account of the user identifies the contact information of the user.

8. The computer-implemented method of claim 1, wherein retrieving, by the at least one processor from the digital repository, the set of contact information associated with the set of users comprises:
retrieving, by the at least one processor from the digital repository, (i) the set of contact information associated with the set of users, and (ii) a set of products for which the set of users have completed a set of reviews.

9. A system for managing user-submitted reviews of products, comprising:
a transceiver in communication with an electronic device of a user;
a memory storing a set of computer-readable instructions; and
at least one processor interfacing with the transceiver and the memory, and configured to execute the set of computer-readable instructions to cause the at least one processor to:
receive an identification of a product purchased by the user,
transmit, to the electronic device via the transceiver, an offer to review the product, wherein the electronic device (i) receives, via a user interface, a review of the product, and (ii) transmits the review of the product to a digital repository that avails the review of the product via a website associated with the product,
retrieve, from the digital repository, a set of contact information associated with a set of users,
determine that contact information of the user is included in the set of contact information retrieved from the digital repository, and
in response to determining that the contact information of the user is included in the set of contact information:
apply a digital reward to an account of the user, and
transmit, to the electronic device via the transceiver, a notification of the digital reward.

10. The system of claim 9, wherein to receive the identification of the product purchased by the user, the at least one processor is configured to:
receive, from the electronic device via the transceiver, a digital image depicting a receipt indicating that the product was purchased.

11. The system of claim 10, wherein the at least one processor is configured to execute the set of computer-readable instructions to further cause the at least one processor to:
perform an image analysis on the digital image to determine that the product is included on the receipt.

12. The system of claim 9, wherein to receive the identification of the product purchased by the user, the at least one processor is configured to:
retrieve, from an additional digital repository associated with the user, a digital record indicating that the product was purchased.

13. The system of claim 9, wherein the website offers the product for sale, and wherein the digital repository sends the review of the product to the website.

14. The system of claim 9, wherein the at least one processor is configured to execute the set of computer-readable instructions to further cause the at least one processor to:
after receiving the identification of the product, determine the digital reward associated with the user completing the review of the product.

15. The system of claim 9, wherein the account of the user identifies the contact information of the user.

16. The system of claim 9, wherein to retrieve, from the digital repository, the set of contact information associated with the set of users, the at least one processor is configured to:
retrieve, from the digital repository, (i) the set of contact information associated with the set of users, and (ii) a set of products for which the set of users have completed a set of reviews.

17. A system for managing digital rewards associated with product reviews, comprising:
a memory storing a set of computer-readable instructions; and
at least one processor interfacing with the memory, and configured to execute the set of computer-readable instructions to cause the at least one processor to:
determine that a user purchased a product, wherein there is a digital reward associated with the user completing a review of the product,
avail a notification of the digital reward to an account associated with the user,
access the review of the product, the review of the product including contact information associated with a submission of the review of the product, wherein the review of the product is availed via a website associated with the product,
determine that the contact information included in the review of the product matches stored contact information associated with the account associated with the user, and
in response to determining that the contact information matches the stored contact information, apply the digital reward to the account of the user.

18. The system of claim 17, wherein to access the review of the product, the at least one processor is configured to:
retrieve, from a digital repository, the review of the product.

19. The system of claim 17, wherein to avail the notification of the digital reward to the account associated with the user, the at least one processor is configured to:
transmit, to an electronic device of the user, the notification of the digital reward.

20. The system of claim 19, wherein the electronic device (i) receives, via a user interface, the review of the product, and (ii) transmits the review of the product to a digital repository that avails the review of the product via the website.
